(19) United States
(12) Patent Application Publication
(10) Pub. No.: US 2021/0282369 A1
(43) Pub. Date: Sep. 16, 2021

(54) ANIMAL WATER DISPENSER

(71) Applicant: SHENZHEN JINCAN PET PRODUCTS CO., LTD., Shenzhen (CN)

(72) Inventor: Xiaocan TAO, Shenzhen (CN)

(21) Appl. No.: 17/334,822

(22) Filed: May 31, 2021

Related U.S. Application Data
(63) Continuation of application No. PCT/CN2020/094194, filed on Jun. 3, 2020.

(30) Foreign Application Priority Data
Jun. 6, 2019 (CN) 201920867954.0

(51) Int. Cl. A01K 7/02

(52) U.S. Cl. CPC A01K 7/025

(57) ABSTRACT

An animal water dispenser is disclosed, including a water storage tank, a water pump provided at a bottom of the water storage tank, the water pump being provided with a water inlet side, a limit side and two positioning sides; water in the water storage tank entering the water pump from the water inlet side , the limit side being provided opposite to the water inlet side, the two positioning sides being opposite to each other and both connected with the water inlet side and the limit side; a positioning block being provided on each positioning side, a positioning hole being defined on each positioning block, a positioning column being provided on the bottom of the water storage tank, two positioning holes being respectively sleeved on the two positioning columns, the bottom of the water storage tank being convexly provided with a baffle for abutting against the limit side.

This application is a continuation of International Application No. PCT/CN2020/094194, filed on Jun. 3, 2020, which claims priority to Chinese Application No. 201920867954.0, filed on Jun. 6, 2019. The entire disclosures of the aforementioned applications are incorporated herein by reference.

### TECHNICAL FIELD

The present application relates to the technical field of animal automatic raising, in particular to an animal water dispenser.

### BACKGROUND

With the development of society and the improvement of living standards, raising animals has become a common practice, cats and dogs are the most common animals. A relatively high amount of water is contained in a body of an animal, and the animal need to take in enough water every day to maintain its health. Accordingly, many related products have been developed, and the animal water dispenser is one of those.

Most of the animal water dispensers on the market have automatic water outlets. An animal water dispenser generally includes a water storage tank, a water pump, and a drinking basin. Due to the complex surface structure of the water pump, for example, there are many radiating ribs on the surface of the water pump, and there are also positioning ribs on the surface of the water pump for ensuring the stable placement of the water pump, or the like, the bottom surface of the water storage tank will be complicatedly configured correspondingly in order to install the water pump, which makes it difficult to clean the surfaces of the water pump and the water storage tank.

### SUMMARY

One of the objectives of embodiments of the present application is to provide an animal water dispenser, which aims to solve a problem of difficulty in cleaning due to complicated structures of surfaces of the water pump and the water storage tank in the related art.

To solve the above technical problem, a technical solution adopted in the embodiments of the present application is that:

in a first aspect, an animal water dispenser is provided, including a water storage tank, a water pump being provided at a bottom of the water storage tank, a bottom of the water pump being flat, and an outer periphery of the water pump being provided with a water inlet side, a limit side and two positioning sides, water in the water storage tank entering the water pump from the water inlet side, the limit side being provided opposite to the water inlet side, and the two positioning sides being opposite to each other and both connected with the water inlet side and the limit side; a positioning block being convexly provided on each of the positioning sides, a positioning hole being defined on each of the positioning blocks, positioning columns being convexly provided on the bottom of the water storage tank, two positioning holes being respectively sleeved on the two positioning columns correspondingly, the bottom of the water storage tank being convexly provided with a baffle for abutting against the limit side.

In one embodiment, each of the positioning columns is ladder-shaped, and each of the positioning columns comprises a large-diameter section connected with the bottom of the water storage tank, and a small-diameter section connected with the large-diameter section, each of the positioning holes is a ladder-shaped hole and comprises a large-diameter hole matched with the large-diameter section, and a small-diameter hole connected with the large-diameter hole and matched with the small-diameter section.

In one embodiment, the water inlet side of the water pump is provided with a detachable installation frame, and the installation frame is provided with a sponge for filtration of the water in the water storage tank.

In one embodiment, each of the positioning sides is defined with a sliding groove extended in a vertical direction, the installation frame is provided around an outer periphery of the water inlet side and at least part of the positioning sides, and two ends of the installation frame are clamped in two sliding grooves of the positioning sides, correspondingly.

In one embodiment, the bottom of the water storage tank is recessed from an outside to an inside to form hand clasp grooves for hand to hand, and the hand clasp grooves are evenly distributed around the bottom of the water storage tank, and a concave depth of each hand clasp groove is gradually decreased from a periphery of the water storage tank to a center of the bottom.

In one embodiment, a viewing window is defined on a side wall of the water storage tank, and a transparent strip is provided at the viewing window and extended along a height direction of the water storage tank and provided with a scale line for reflecting a height of the water in the water storage tank.

In one embodiment, at least one of the limit side and the two positioning sides is provided with a water level detector for detecting a water level in the water storage tank, and an inside of the water pump is provided with a circuit board which is respectively electrically connected with the water level detector and the water pump and configured to determine whether to control the water pump to power off according to the water level sent by the water level detector, and the circuit board is sealed in the water pump by epoxy resin.

In one embodiment, the animal water dispenser further comprises a drinking basin and a filter assembly, the drinking basin comprises a suction pipe and a ring sink, and the suction pipe is connected between the water pump and the ring sink, water exceeding a first height in the ring sink automatically flow downward through the filter assembly and back to the water storage tank.

In one embodiment, the ring sink comprises an inner wall, a sink bottom and an outer wall sequentially connected from an inside to an outside, and the suction pipe is connected with a center of the inner wall, the inner wall has a steep downward slope from the suction pipe to the sink bottom, and the inner wall is provided with water flow steps distributed along an circumferential direction and recessed inward, and the water flow steps are extended from a center of the inner wall to the sink bottom, and a width of each of the water flow steps in the circumferential direction is gradually increased from the center of the inner wall to the sink bottom.

In one embodiment, an outer edge of the outer wall is provided with a plurality of water outlet grooves distributed along the circumferential direction and configured for the water and foreign matters to flow to the filter assembly, and the water outlet grooves are extended in the circumferential direction of the outer wall.

The beneficial effects of the animal water dispenser provided by the embodiments of the present application are: compared with the related art, the water pump of the animal water dispenser of the present application has a flat bottom, such that the water pump can be placed stably without positioning ribs, and the water pump and the water storage tank are installed and connected through simple positioning blocks and baffles, so that only two positioning blocks are provided on the outer peripheral surface of the water pump, and only two positioning columns and one baffle are provided at the bottom of the water storage tank, so that the surface structures of the water pump and the water storage tank are simple and easy to be cleaned, and the water pump and the water storage tank are easy to be disassembled, replaced and maintained.

### BRIEF DESCRIPTION OF THE DRAWINGS

In order to more clearly describe the technical solutions in the embodiments of the present application, the following will briefly introduce the drawings that need to be used in the embodiments or exemplary technical descriptions. Obviously, the drawings in the following description are merely for some embodiments of the present application, for those of ordinary skill in the art, other drawings may be obtained based on these drawings without creative work.

FIG. 1 is a schematic structural view of an animal water dispenser provided by an embodiment of the present application.

FIG. 2 is a schematic view of an assembly of a water pump and a water storage tank in FIG. 1.

FIG. 3 is a schematic view of an internal structure of the water storage tank in FIG. 1.

FIG. 4 is a schematic structural view of the water pump in FIG. 1.

FIG. 5 is a schematic view of an assembly of the water pump and an installation frame in FIG. 1.

FIG. 6 is a schematic structural view of the installation frame in FIG. 5.

FIG. 7 is a schematic cross-sectional view of the animal water dispenser in FIG. 1.

FIG. 8 is a schematic structural view of a drinking basin in FIG. 1.

In order to make the objectives, technical solutions, and advantages of the present application more clear, the present application will be further described in detail below with reference to the accompanying drawings and embodiments. It should be understood that the specific embodiments described here are only used to explain the present invention, and are not used to limit the present application.

### DETAILED DESCRIPTION OF THE EMBODIMENTS

It should be noted that when a component is referred to as being “fixed to” or “provided on” another component, it can be directly or indirectly on the other component. When a component is defined to be “connected with” another component, it can be directly or indirectly connected with the other component. The terms “upper”, “lower”, “left”, “right”, etc. indicate an orientation relationship or a positional relationship based on the orientation or positional relationship shown in the drawings, and are only for ease of illustration, and do not indicate or imply the device or the element referred to must have a specific orientation and be constructed and operated in a specific orientation, and therefore they cannot be construed as limitations of the present application. For those of ordinary skill in the art, the specific meaning of the above terms can be understood according to specific conditions. The terms “first” and “second” are only used for ease of illustration, and cannot be understood as indicating or implying relative importance or implicitly indicating the number of technical features. The meaning of “plurality” means two or more than two, unless otherwise specifically defined.

In order to illustrate the technical solutions described in the present application, the following detailed descriptions are given in conjunction with specific drawings and embodiments.

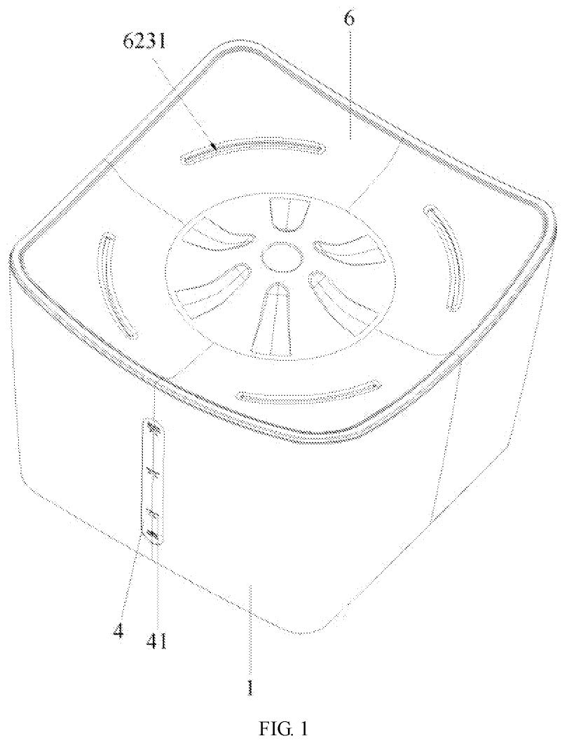

Please refer to FIGS. 1 to 4, the animal water dispenser provided in the present application will now be described.

The animal water dispenser includes a water storage tank 1 and a water pump 2. An inner surface of the water storage tank 1 is smooth. The water pump 2 is provided at a bottom of the water storage tank 1. The water pump 2 is square, and a bottom of the water pump 2 is flat, and an outer periphery of the water pump 2 are provided with a water inlet side 21, a limit side 22 and two positioning sides 23. Water in the water storage tank 1 enters the water pump 2 from the water inlet side 21. The limit side 22 is provided opposite to the water inlet side 21, and the two positioning sides 23 are opposite to each other and both connected with the water inlet side 21 and the limit side 22. A positioning block 24 is convexly provided on each positioning side 23. A positioning hole 240 is defined on each positioning block 24. Positioning columns 11 are convexly provided on the bottom of the water storage tank 1, and two positioning holes 240 are respectively sleeved on the two positioning columns 11 correspondingly. The bottom of the water storage tank 1 is convexly provided with a baffle 12 for abutting against the limit side 22.

In this embodiment, when installing the water pump 2, first the water pump 2 is stably placed on the bottom of the water storage tank 1, and then the two positioning holes 240 are directly sleeved on the two positioning columns 11 respectively, and finally the baffle 12 is made to abut against the limit side 22. Or in order to install the water pump 2 stably, a suction cup can be provided at the bottom of the water pump 2, and the water pump 2 can be more stably installed at the bottom of the water storage tank 1 through the suction cup. When the water storage tank 1 and the water pump 2 need to be cleaned, the water pump 2 can be directly removed from the water storage tank 1 for cleaning.

The animal water dispenser provided by the present application is to provide the water pump 2 with a flat bottom, which can be placed stably without positioning ribs, and the water pump 2 and the water storage tank 1 are simply installed and connected through the positioning blocks 24 and the baffle 12, so that the outer peripheral surface of the water pump 2 is provided with only two positioning blocks 24, and the bottom of the water storage tank 1 is provided with only two positioning columns 11 and a baffle 12, the surfaces of the water pump 2 and the water storage tank 1 have simple structures and are easy to be cleaned, and the water pump 2 and the water storage tank 1 are easy to be disassembled, replaced and maintained.

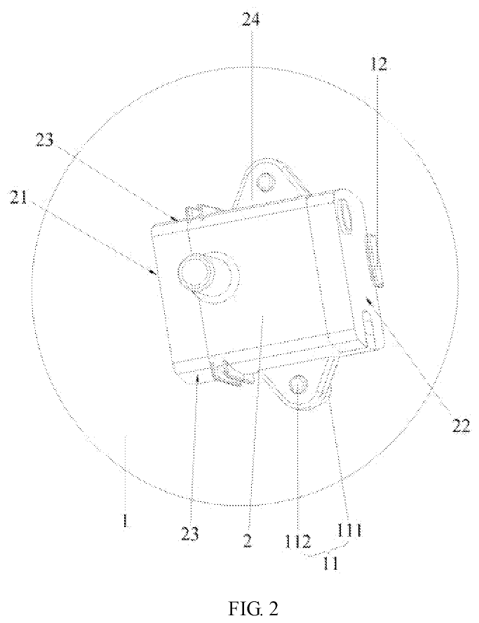

In this embodiment, a width of the baffle 12 in a front-to-rear direction in FIG. 2 is less than one third of a width of the water pump 2 in the front-to-rear direction in FIG. 2, thereby making the structure of the baffle 12 to be small and cleaned easily, and meanwhile making a distance between the baffle 12 and the two positioning columns 11 to be large and facilitating cleaning. Understandably, in other embodiments of the present application, according to actual conditions and specific requirements, the width of the baffle 12 can be provided slightly larger, as long as the baffle 12 and the water storage tank 1 are easily cleaned, which is not uniquely limited here.

In this embodiment, please refer to FIG. 2, each positioning column 11 is ladder-shaped. Each positioning column 11 includes a large-diameter section 111 and a small-diameter section 112. The large-diameter section 111 is connected with the bottom of the water storage tank 1, and the small-diameter section 112 is connected with the large-diameter section 111. Each positioning hole 240 is a ladder-shaped hole. Each positioning hole 240 includes a large-diameter hole and a small-diameter hole. The large-diameter hole is matched with the large-diameter section 111, and the small-diameter hole is connected with the large-diameter hole and matched with the small-diameter section 112. In this embodiment, the large-diameter hole and the large-diameter section 111 are in clearance fit, and the small-diameter hole and the small-diameter section 112 are also in clearance fit, thereby facilitating the disassembly of the water pump 2. Understandably, in other embodiments of the present application, according to actual conditions and specific requirements, when there is no suction cup for fixing, the large-diameter hole and the large-diameter section 111 can be in interference fit, and the small-diameter hole and the small-diameter section 112 can be in interference fit, thereby ensuring a stable installation between the water pump 2 and the water storage tank 1, which is not uniquely limited here.

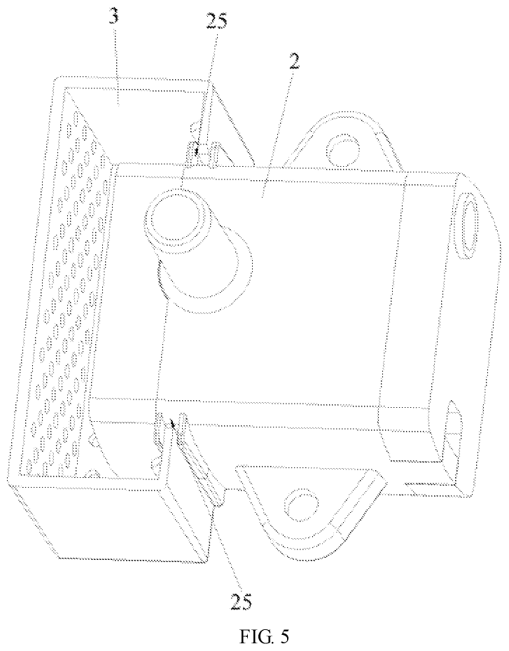

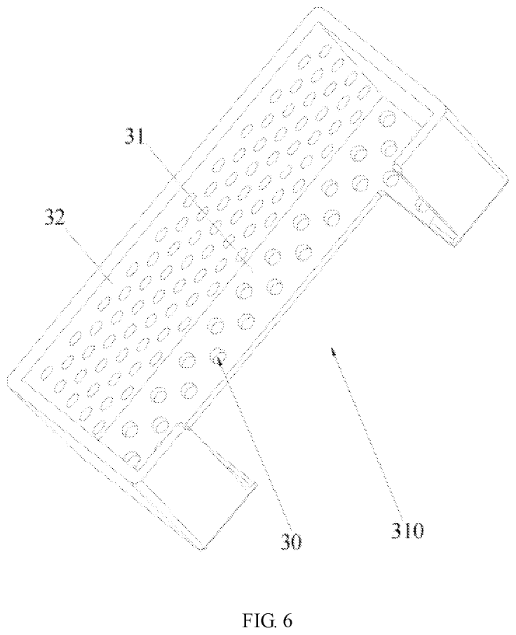

In this embodiment, please refer to FIGS. 5 and 6, the water inlet side 21 of the water pump 2 is provided with an installation frame 3, which is detachably provided on the water pump 2, and the installation frame 3 is provided with a sponge for preliminary filtration of the water in the water storage tank 1. In this embodiment, the installation frame 3 for installing the sponge is provided on the water pump 2 and the sponge is provided in the installation frame 3, which not only enables the water in the water storage tank 1 to be primarily filtered before entering the water pump 2, thereby preventing animal hairs from entering the water pump 2, but also avoids that an installation structure for installing a sponge is extended from the bottom of the water storage tank 1 or from the water pump 2, so that the surfaces of the water storage tank 1 and the water pump 2 have simple structures and are easy to be cleaned.

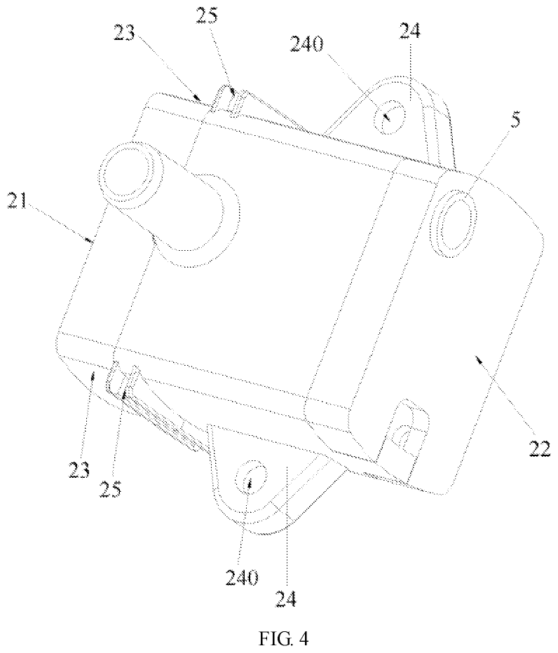

In this embodiment, please refer to FIGS. 4 and 5, each of the two positioning sides 23 is provided with a sliding groove 25. Specifically, the sliding grooves 25 are provided close to the water inlet side 21, and the sliding grooves 25 extend in a vertical direction. The installation frame 3 is provided around the outer periphery of the water inlet side 21 and at least part of the positioning side 23, and two ends of the installation frame 3 are clamped in the two sliding grooves 25, correspondingly.

Specifically, the installation frame 3 includes a bottom plate 31 and a side plate 32. The bottom plate 31 is in a shape of a flat plate. The bottom plate 31 is provided with an U-shaped groove 310. An opening of the U-shaped groove 310 faces toward the water pump 2, and the U-shaped groove 310 is sleeved on the water inlet side 21 and parts of the positioning sides 23 of the water pump 2. The side plate 32 extends vertically upward from the outer peripheral edge of the bottom plate 31, two ends of the side plate 32 are slidably provided in the two sliding grooves 25, and the bottom plate 31 and the side plate 32 are evenly distributed with through holes 30 for the water in the water storage tank 1 to enter.

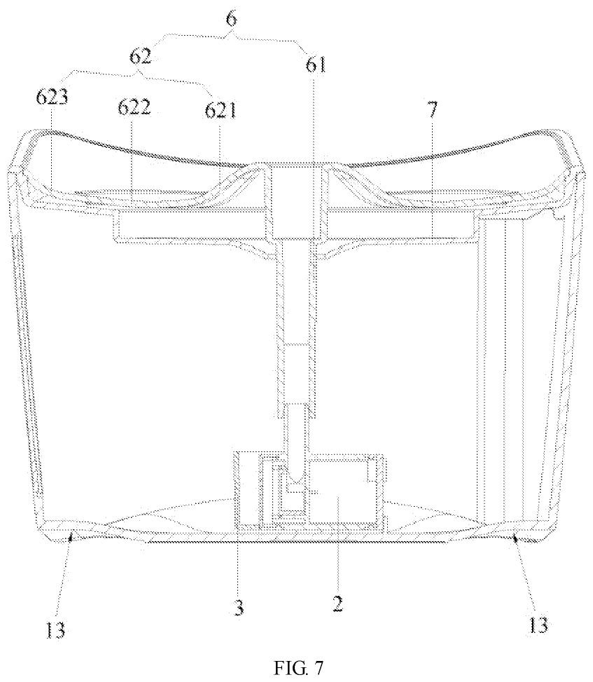

In this embodiment, please refer to FIG. 7, the bottom of the water storage tank 1 is recessed from the outside to the inside to form hand clasp grooves 13 for hands to hand, and the hand clasp grooves 13 are evenly distributed around the bottom of the water storage tank 1. Specifically, in this embodiment, the water storage tank 1 is roughly square, the bottom of the water storage tank 1 corresponding to each of the four sides is defined with a hand clasp groove 13, and a concave depth of each hand clasp groove 13 gradually decreases from the periphery of the water storage tank 1 to a center of the bottom thereof, which not only makes the water storage tank 1 easy to be carried, but also makes an appearance of the water storage tank 1 beautiful. In addition, each side of an top of the water storage tank 1 is concave arc shaped, and the concave structures distributed at the top of the water storage tank 1 are corresponding to the concave structures distributed at the bottom, thereby further making the appearance of the water storage tank 1 beautiful.

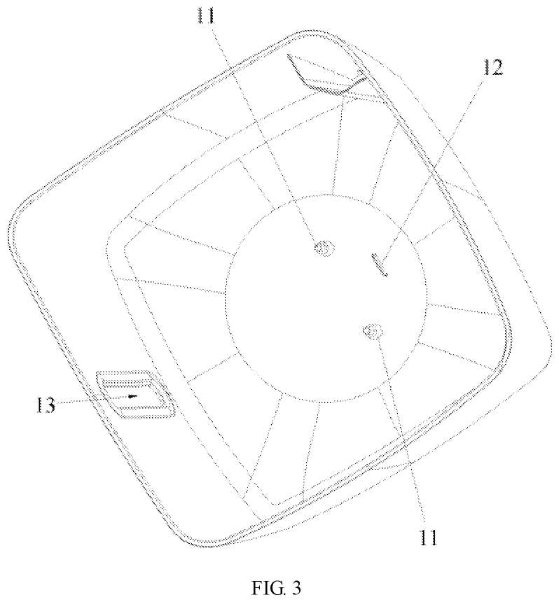

In this embodiment, please refer to FIGS. 1 and 3, a viewing window 14 is defined on a side wall of the water storage tank 1. The viewing window 14 extends in the vertical direction, and a transparent strip 4 is provided at the viewing window 14. The transparent strip 4 extends along a height direction of the water storage tank 1. The transparent strip 4 is provided with a scale line 41 for reflecting a height of water in the water storage tank 1, so that the user can get an approximate water level in the water storage tank 1 through the transparent strip 4, and get an accurate water level in the water storage tank 1 by reading the scale line 41, so as to facilitate the user to determine whether to add or change the water.

Specifically, in this embodiment, the viewing window 14 is provided stepped, and a periphery of the transparent strip 4 is stepped. The transparent strip 4 is made of soft rubber material, so that the transparent strip 4 can be clamped to the viewing window 14. Understandably, in other embodiments of the present application, according to actual conditions and specific requirements, the transparent strip 4 may be made of a hard transparent material, and the transparent strip 4 may be provided on the viewing window 14 through an adhesive or a fastener, which is not uniquely limited here.

In this embodiment, the transparent strip 4 is in a waist shape and beautiful in structure. Understandably, in other embodiments of the present application, the transparent strip 4 may be rectangular or in another shape, which is not exclusively limited here.

In this embodiment, please refer to FIG. 4, the limit side 22 is provided with a water level detector 5, and a circuit board (not shown in the figures) is provided in the water pump 2. The circuit board is sealed in the water pump 2 by epoxy resin. The circuit board is electrically connected with the water level detector 5 and the water pump 2, respectively. The water level detector 5 is configured to detect a water level in the water storage tank 1 and send information of the water level to the circuit board, and the circuit board is configured to receive the information of the water level sent by the water level detector 5 and determine whether there is lack of water. When the circuit board determines lack of water, a control command is sent to control the water pump 2 to power off. Specifically, in this embodiment, an internal circuit of the water pump 2 is connected with an external circuit through the bottom of the water storage tank 1, and is sealed by a sealing structure. In this embodiment, the circuit board is sealed in the water pump 2, so that the structures of the surfaces of the water pump 2 and the water storage tank 1 are tidy and easy to be cleaned.

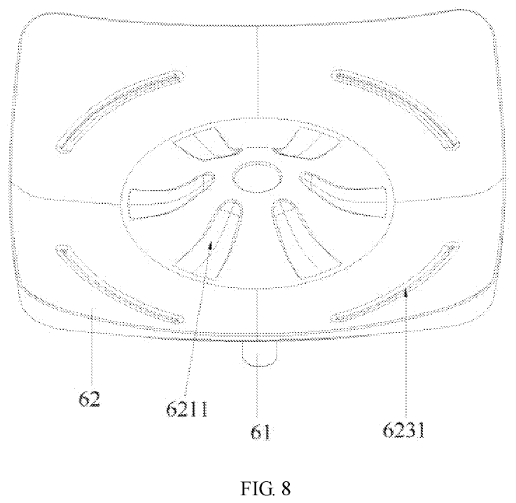

In this embodiment, please refer to FIGS. 7 and 8, the animal water dispenser also includes a drinking basin 6 and a filter assembly 7. The drinking basin 6 includes a suction pipe 61 and an ring sink 62. The suction pipe 61 is connected between the water pump 2 and the ring sink 62. The ring sink 62, the filter assembly 7 and the water storage tank 1 are arranged sequentially from the top to the bottom. When exceeding a first height, the water in the ring sink 62 will automatically flow downward through the filter assembly 7 and flow back to the water storage tank 1. The first height can be determined according to the actual situation. For example, for an animal drinking a large amount of water, the first height can be set higher to meet the drinking need of the animal, and for an animal drinking a small amount of water, the first height can be set lower to prevent the water from staying in the ring sink 62 all the time, which causes the water to be not fresh enough, and many foreign matters exist in the water, which is unhealthy and environmentally friendly.

Specifically, the suction pipe 61 is provided in a vertical direction, a water inlet of the suction pipe 61 is connected with the water pump 2, a water outlet of the suction pipe 61 is connected with the ring sink 62, and the suction pipe 61 sequentially penetrates and passes the water storage tank 1 and the filter assembly 7.

In this embodiment, please refer to FIG. 7, the ring sink 62 includes an inner wall 621, a sink bottom 622, and an outer wall 623 that are sequentially connected from an inside to an outside. The inner wall 621, the sink bottom 622 and the outer wall 623 all extend in a circumferential direction. The suction pipe 61 is connected with a center of the inner wall 621. The inner wall 621 has a steep downward slope from the suction pipe 61 to the sink bottom 622, and a connection between the suction pipe 61 and the inner wall 621 is provided with rounded corners, so that the water gushes into the ring sink 62 and gives animals a novel feeling and increasing their interest in drinking water.

Please refer to FIG. 8, an upper inner wall 621 is provided with water flow steps 6211 distributed along the circumferential direction and concave inward. The water flow steps 6211 extend from a center of the inner wall 621 to the sink bottom 622, and a width of each water flow step 6211 in the circumferential direction gradually increases from the center of the inner wall 621 to the sink bottom 622, so that the water becomes turbulent after being sprayed under the action of the water flow step 6211, and a contact area between air and the water is increased, so that the oxygen can be fully dissolved in the water flow, and the oxygen in the water is increased, thereby pets can drink healthy living water at any time.

In this embodiment, please refer to FIG. 8, an outer edge of the outer wall 623 is provided with a plurality of water outlet grooves 6231. The water outlet grooves 6231 are distributed in the circumferential direction of the ring sink 62 and extend in the circumferential direction of the outer wall 623. Each water outlet groove 6231 is configured for the water and the foreign matters to flow to the filter assembly 7 and back to the water storage tank 1, so that when reaching the first height, the water in the ring sink 62 will flow to the filter assembly 7, and flow back to the water storage tank 1 after being filtered by the filter assembly 7, thereby forming a water circulation system. In addition, in this embodiment, the foreign matters generally refers to animal hairs or some dust dropped into the ring sink 62, as such, it prevents the hairs and other foreign matters from being immersed in water for a long time to breed bacteria and result in unhealthy water.

In this embodiment, the ring sink 62 is provided with four water outlet grooves 6231, and the water outlet grooves 6231 are evenly spaced along the circumferential direction of the annular water groove 62. Understandably, in other embodiments of the present invention, three, five, or more than five water outlet grooves 6231 may be provided on the ring sink 62, and a spaces between adjacent water outlet grooves may also be set to be unequal according to actual conditions, which is not uniquely limited here.

Please refer to FIG. 3, in this embodiment, the above water outlet groove 6231 extends along the circumferential direction of the ring sink 62, that is, each water outlet groove 6231 is arc-shaped, and a width of the water outlet groove 6231 along a radial direction of the ring sink 62 is adjusted based on the actual sizes of the foreign matters, which is not uniquely limited here.

The above are only optional embodiments of the present application, and are not used to limit the present application. For those skilled in the art, the present application can have various modifications and changes. Any modification, equivalent replacement, improvement, etc. made within the spirit and principle of the present application shall be included in the scope of the claims of the present application.

What is claimed is:

1. An animal water dispenser, comprising a water storage tank, a water pump being provided at a bottom of the water storage tank, a bottom of the water pump being flat, and an outer periphery of the water pump being provided with a water inlet side, a limit side and two positioning sides, water in the water storage tank entering the water pump from the water inlet side, the limit side being provided opposite to the water inlet side, and the two positioning sides being opposite to each other and both connected with the water inlet side and the limit side; a positioning block being convexly provided on each of the positioning sides, a positioning hole being defined on each of the positioning blocks, positioning columns being convexly provided on the bottom of the water storage tank, two positioning holes being respectively sleeved on the two positioning columns correspondingly, the bottom of the water storage tank being convexly provided with a baffle for abutting against the limit side.

2. The animal water dispenser according to claim 1, wherein each of the positioning columns is ladder-shaped, and each of the positioning columns comprises a large-diameter section connected with the bottom of the water storage tank, and a small-diameter section connected with the large-diameter section, each of the positioning holes is a ladder-shaped hole and comprises a large-diameter hole matched with the large-diameter section, and a small-diameter hole connected with the large-diameter hole and matched with the small-diameter section.

3. The animal water dispenser according to claim 1, wherein the water inlet side of the water pump is provided with a detachable installation frame, and the installation frame is provided with a sponge for filtration of the water in the water storage tank.

4. The animal water dispenser according to claim 3, wherein each of the positioning sides is defined with a sliding groove extended in a vertical direction, the installation frame is provided around an outer periphery of the water inlet side and at least part of the positioning sides, and two ends of the installation frame are clamped in two sliding grooves of the positioning sides, correspondingly.

5. The animal water dispenser according to claim 1, wherein the bottom of the water storage tank is recessed from an outside to an inside to form hand clasp grooves for hand to hand, and the hand clasp grooves are evenly distributed around the bottom of the water storage tank, and a concave depth of each hand clasp groove is gradually decreased from a periphery of the water storage tank to a center of the bottom.

6. The animal water dispenser according to claim 1, wherein a viewing window is defined on a side wall of the water storage tank, and a transparent strip is provided at the viewing window and extended along a height direction of the water storage tank and provided with a scale line for reflecting a height of the water in the water storage tank.

7. The animal water dispenser according to claim 1, wherein at least one of the limit side and the two positioning sides is provided with a water level detector for detecting a water level in the water storage tank, and an inside of the water pump is provided with a circuit board electrically connected with the water level detector and the water pump and configured to determine whether to control the water pump to power off according to the water level sent by the water level detector, and the circuit board is sealed in the water pump by epoxy resin.

8. The animal water dispenser according to claim 1, wherein the animal water dispenser further comprises a drinking basin and a filter assembly, the drinking basin comprises a suction pipe and a ring sink, and the suction pipe is connected between the water pump and the ring sink, water exceeding a first height in the ring sink automatically flow downward through the filter assembly and back to the water storage tank.

9. The animal water dispenser according to claim 8, wherein the ring sink comprises an inner wall, a sink bottom and an outer wall sequentially connected from an inside to an outside, and the suction pipe is connected with a center of the inner wall, the inner wall has a steep downward slope from the suction pipe to the sink bottom, and the inner wall is provided with water flow steps distributed along an circumferential direction and recessed inward, and the water flow steps are extended from a center of the inner wall to the sink bottom, and a width of each of the water flow steps in the circumferential direction is gradually increased from the center of the inner wall to the sink bottom.

10. The animal water dispenser according to claim 9, wherein an outer edge of the outer wall is provided with a plurality of water outlet grooves distributed along the circumferential direction and configured for the water and foreign matters to flow to the filter assembly, and the water outlet grooves are extended in the circumferential direction of the outer wall.
